(19) United States
(12) Patent Application Publication
(10) Pub. No.: US 2019/0275424 A1
(43) Pub. Date: Sep. 12, 2019

(54) METHOD AND SYSTEM FOR GAME REPLAY

(71) Applicant: LINE Up Corporation, Seongnam-si (KR)

(72) Inventors: Yong Hyun LEE, Seongnam-si (KR); Jung Min PARK, Seongnam-si (KR)

(73) Assignee: LINE Up Corporation, Seongnam-si (KR)

(21) Appl. No.: 16/298,100

(22) Filed: Mar. 11, 2019

(30) Foreign Application Priority Data
Mar. 12, 2018 (KR) 10-2018-0028904

(51) Int. Cl. A63F 13/493; A63F 13/86; A63F 13/35

(52) U.S. Cl. CPC A63F 13/493; A63F 13/35; A63F 13/86

(57) ABSTRACT

A game replay method includes providing a list of games played by a user; replaying a game selected from the list of games based on game data corresponding to the selected game; providing a recording function of the game being replayed; generating and storing a video of the game being replayed through the recording function; and providing a share function for at least one of the stored video and an access link to the game data.

### CROSS-REFERENCE TO RELATED APPLICATION(S)

This U.S. non-provisional application claims the benefit of priority under 35 U.S.C. § 119 to Korean Patent Application No. 10-2018-0028904 filed on Mar. 12, 2018, in the Korean Intellectual Property Office (KIPO), the entire contents of which are incorporated herein by reference.

### BACKGROUND

### Field

One or more example embodiments relate to a game replay method and system, and more particularly, to a game replay method that may replay content of a game played by game users, may generate a video of the game being replayed, and may share the video and/or a link for replaying the game with other users, a computer apparatus for performing the game replay method, a computer program stored in a non-transitory computer-readable medium to perform the game relay method on the computer apparatus in conjunction with the computer apparatus, and a non-transitory computer-readable medium storing instructions that, when caused by a processor, cause the processor to perform the game replay method.

### Description of Related Art

A game replay refers to a function that allows a user or another user to view a game previously played by the user or the other user in a game service. For example, a specific user may access replay of a game previously played by the specific user or another user and may view the game again. Korean Patent Laid-Open Publication No. 10-2009-0129110 relates to a system and method for providing replay of an online game. Here, when a user desires to view an event in a game that has been present in the past regardless of whether the user has participated in the game, the user may enter a keyword indicating the event of the game and a time at which the game is played and may receive a replay file of the event of the game corresponding to the keyword and the time.

However, such related arts relate to a replay service that is provided to a user of a game service. Accordingly, if a user is not the user of the game service, it is difficult to access data for replay in the game service. For example, a user of a corresponding game service needs to generate and edit a separate video and then provide the video so that another user or a plurality of users may view replay of a corresponding game played by the user of the game service through a social network service (SNS).

### SUMMARY

According to at least some example embodiments, a game replay method includes providing a list of games played by a user; replaying a game selected from the list of games based on game data corresponding to the selected game; providing a recording function of the game being replayed; generating and storing a video of the game being replayed through the recording function; and providing a share function for at least one of the stored video and an access link to the game data.

The providing of the share function may include receiving a selection on the stored video through the share function; providing a list of share platforms through the share function; executing a share application corresponding to a share platform selected from the provided list of share platforms; and transmitting the selected video and the access link to the game data to the executed share application.

The access link may include information on a location in a network at which the game data is stored, and information to install or execute a game application capable of replaying the game using the game data.

The access link may include information on a location in a network at which the game data is stored, and the method may further comprises providing, by a server that stores the game data at the location in the network, an instruction for installing or executing a game application capable of replaying the game using the game data.

The providing of the list of games may include receiving the list of games from a server that generates and stores the list of games played by the user and game data corresponding to each of the games included in the list, and displaying the received list of games on a screen.

The game may include at least one of an attack game played by the user as an attacker, a defense game played by the user as a defender, and a participation game in which a user participates after being initiated by other users, and the list of games may include a list of attack games, a list of defense games, and a list of participation games.

The generating and the storing of the video may include generating a video of a game being replayed during a desired period of time from a point in time at which an input of the user occurs through the recording function, and storing the generated video on a terminal of the user.

According to at least some example embodiments, a game replay method includes generating a list of games played by a first user and game data for replaying a game; providing the list of games in response to a request from a terminal of the first user; providing game data corresponding to a game selected from the list of games by the terminal of the first user to be replayed on the terminal of the first user; and providing the game data to a terminal of a second user that accesses the game data generated at the terminal of the first user through an access link.

The game replay method may further include replaying the selected game on the terminal of the first user, based on the game data under control of a game application that is installed and executed on the terminal of the first user; generating a video through a recording function provided under control of the game application while the selected game is being replayed; and transmitting the generated video and an access link to the game data to the second user through a share application selected through a share function.

The game may include at least one of an attack game played by the first user as an attacker, a defense game played by the first user as a defender, and a participation game in which a user participates after being initiated by other users, and the list of games may include a list of attack games, a list of defense games, and a list of participation games.

According to at least some example embodiments, a non-transitory computer-readable recording medium may store instructions that, when executed by a processor, cause the processor to perform the game replay method.

According to at least some example embodiments, a computer apparatus includes memory storing computer-executable instructions; and at least one processor configured to execute computer-executable instructions such that the at least one processor is configured to, generate a list of games played by a first user and game data for replaying a game, provide the list of games in response to a request from a terminal of the first user, provide game data corresponding to a game selected from the list of games by the terminal of the first user to be replayed on the terminal of the first user, and provide the game data to a terminal of a second user that accesses the game data generated at the terminal of the first user through an access link.

The at least one processor may be configured to execute computer-executable instructions such that the at least one processor is further configured to, replay the selected game on the terminal of the first user, based on the game data under control of a game application that is installed and executed on the terminal of the first user,

generate a video through a recording function provided under control of the game application while the selected game is being replayed, and transmit the generated video and an access link to the game data to the second user through a share application selected through a share function.

The game may include at least one of an attack game played by the first user as an attacker, a defense game played by the first user as a defender, and a participation game in which a user participates after being initiated by other users, and the list of games may include a list of attack games, a list of defense games, and a list of participation games.

According to some example embodiments, it is possible to replay content of a game played by game users, to generate a video of the game being replayed, and to share the video and/or a link for replaying the game with other users.

Further areas of applicability will become apparent from the description provided herein. The description and specific examples in this summary are intended for purposes of illustration only and are not intended to limit the scope of the present disclosure.

### BRIEF DESCRIPTION OF THE FIGURES

The above and other features and advantages of example embodiments of the inventive concepts will become more apparent by describing in detail example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 illustrates an example of a network environment according to at least one example embodiment;

FIG. 2 illustrates an example of a computer apparatus according to at least one example embodiment;

FIG. 3 is a flowchart illustrating an example of a game replay method of a client according to at least one example embodiment;

FIG. 4 is a flowchart illustrating an example of a game replay method of a server according to at least one example embodiment;

FIG. 5 illustrates an example of a list of games according to at least one example embodiment;

FIG. 6 illustrates an example of a game replay screen according to at least one example embodiment;

FIG. 7 illustrates an example of a recording process according to at least one example embodiment;

FIG. 8 illustrates an example of a video selection process according to at least one example embodiment;

FIG. 9 illustrates an example of a list of share platforms according to at least one example embodiment; and

FIG. 10 illustrates an example of information shared through a share platform according to at least one example embodiment.

It should be noted that these figures are intended to illustrate the general characteristics of methods and/or structure utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments.

### DETAILED DESCRIPTION

One or more example embodiments will be described in detail with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed products. Expressions such as “at least one of,” when preceding a list of elements, modify the entire list of elements and do not modify the individual elements of the list. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Units and/or devices according to one or more example embodiments may be implemented using hardware and/or a combination of hardware and software. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor), Central Processing Unit (CPU), a controller, an arithmetic logic unit (ALU), a digital signal processor, a microcomputer, a microprocessor, etc., the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable storage mediums, including the tangible or non-transitory computer-readable storage media discussed herein.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive, solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blue-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be explained with reference to an example in which there is one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Hereinafter, example embodiments will be described with reference to the accompanying drawings.

A game replay method according to example embodiments may be implemented through a computer apparatus, such as an electronic device or a server, which is described below. Here, a computer program according to example embodiments may be installed and executed on the computer apparatus. The computer apparatus may perform the game replay method according to the example embodiments under control of the executed computer program. The computer program may be stored in a non-transitory computer-readable medium to perform the game replay method on the computer apparatus in conjunction with the computer apparatus.

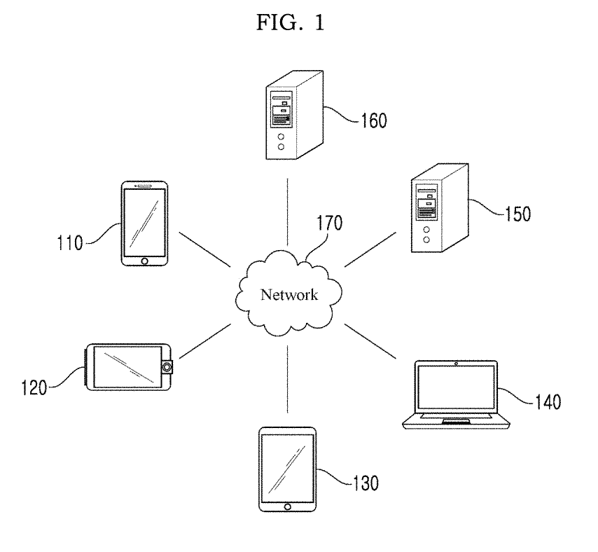

FIG. 1 is a diagram illustrating an example of a network environment according to at least one example embodiment. Referring to FIG. 1, the network environment includes a plurality of electronic devices 110, 120, 130, and 140, a plurality of servers 150 and 160, and a network 170. FIG. 1 is provided as an example only and thus, a number of electronic devices and/or a number of servers are not limited thereto.

Each of the plurality of electronic devices 110, 120, 130, and 140 may be a fixed terminal or a mobile terminal configured as a computer apparatus. For example, each of the plurality of electronic devices 110, 120, 130, and 140 may be any one of, for example, a smartphone, a mobile phone, a navigation, a computer, a laptop computer, a digital broadcasting terminal, a personal digital assistant (PDA), a portable multimedia player (PMP), and a tablet personal computer (PC). For example, although FIG. 1 illustrates a shape of a smartphone as an example of the electronic device 110, the electronic device 110 may refer to one of various physical computer apparatuses capable of communicating with other electronic devices 120, 130, and 140, and/or the servers 150 and 160 over the network 170 in a wired communication manner or in a wireless communication manner.

The communication scheme is not particularly limited and may include a communication method using a near field communication between devices as well as a communication method using a communication network, for example, a mobile communication network, the wired Internet, the wireless Internet, a broadcasting network, etc., which may be included in the network 170. For example, the network 170 may include at least one of network topologies that include, for example, a personal area network (PAN), a local area network (LAN), a campus area network (CAN), a metropolitan area network (MAN), a wide area network (WAN), a broadband network (BBN), and the Internet. Also, the network 170 may include at least one of network topologies that include a bus network, a star network, a ring network, a mesh network, a star-bus network, a tree or hierarchical network, and the like. However, it is only an example and the example embodiments are not limited thereto.

Each of the servers 150 and 160 may be configured as a computer apparatus or a plurality of computer apparatuses that provides instructions, codes, files, contents, services, and the like through communication with the plurality of electronic devices 110, 120, 130, and 140 over the network 170. For example, the server 150 may be a system that provides a service, for example, a game service, a social network service (SNS), a messaging service, a search service, a mail service, and a content providing service, to the plurality of electronic devices 110, 120, 130, and/or 140 over the network 170.

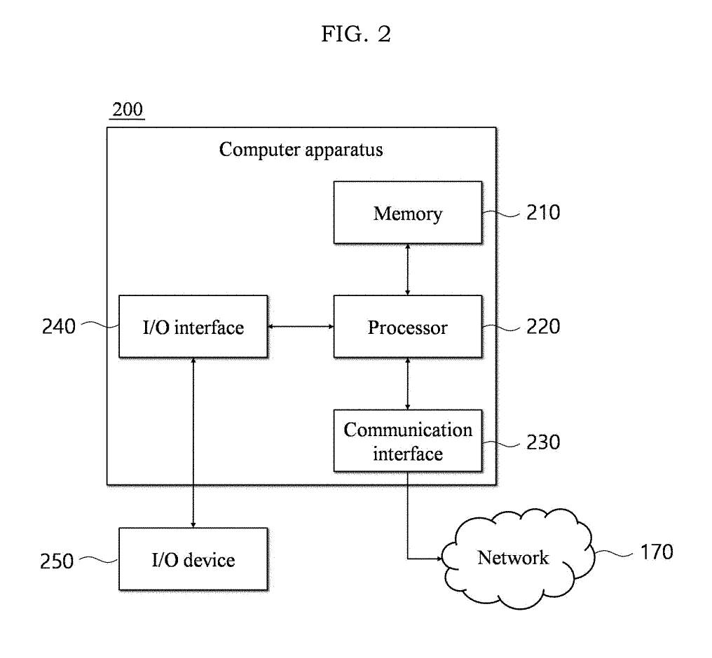

FIG. 2 is a block diagram illustrating an example of a computer apparatus according to at least one example embodiment. Each of the plurality of electronic devices 110, 120, 130, and 140 or each of the servers 150 and 160 may be configured through a computer apparatus 200 of FIG. 2.

Referring to FIG. 2, the computer apparatus 200 may include a memory 210, a processor 220, a communication interface 230, and an input/output (I/O) interface 240. According to at least some example embodiments, the memory 210 may include one or more of known data storage devices examples of which include, but are not limited to, a permanent mass storage device, a hard disc drive (HDD), a solid state drive, flash memory, random access memory (RAM), and read only memory (ROM), as a non-transitory computer-readable storage medium. According to at least some other example embodiments, the memory 210 may be a main memory including, for example RAM, static RAM (SRAM), dynamic RAM (DRAM), or synchronous DRAM (SDRAM) (e.g., volatile memory), and the computer apparatus 200 may further include one or more storage devices (e.g., non-volatile memory) separate from the memory 210, examples of which include, but are not limited to, a permanent mass storage device, a hard disc drive (HDD), a solid state drive, and flash memory. Also, an OS or at least one program code may be stored in the memory 210. Such software components may be loaded to the memory 210 from another non-transitory computer-readable storage medium separate from the memory 210. The other non-transitory computer-readable storage medium may include a non-transitory computer-readable recording medium, for example, a floppy drive, a disk, a tape, a DVD/CD-ROM drive, a memory card, etc. According to other example embodiments, software components may be loaded to the memory 210 through the communication interface 230, instead of, or in addition to, the non-transitory computer-readable storage medium. For example, software components may be loaded to the memory 210 of the computer apparatus 200 based on a computer program installed by files provided over the network 170.

The processor 220 may be configured to process computer-executable instructions of a computer program by performing basic arithmetic operations, logic operations, and I/O operations. The computer-readable instructions may be provided from the memory 210 or the communication interface 230 to the processor 220. For example, the processor 220 may be configured to execute received instructions in response to the program code stored in the storage device, such as the memory 210.

The communication interface 230 may provide a function for communication between the computer apparatus 200 and another apparatus, for example, the aforementioned storage device, over the network 170. For example, the processor 220 of the computer apparatus 200 may transfer a request or an instruction, created based on a program code stored in the storage device such as the memory 210, to other devices over the network 170 under control of the communication interface 230. Inversely, a signal, an instruction, data, etc., from another apparatus may be received at the computer apparatus 200 by going through the communication interface 230 of the computer apparatus 200 and the network 170. For example, a signal, an instruction, data, etc., received through the communication interface 230 may be transferred to the processor 220 or the memory 210, and content, a file, etc., may be stored in a storage medium, for example, the aforementioned permanent storage device, further includable in the computer apparatus 200.

The I/O interface 240 may be a device used for interface with an I/O apparatus 250. For example, an input device may include a device, such as a keyboard and a mouse, and an output device may include a device, such as a display and a speaker. As another example, the I/O interface 240 may be a device for interface with an apparatus in which an input function and an output function are integrated into a single function, such as a touchscreen. The I/O apparatus 250 may be configured as a single apparatus with the computer apparatus 200.

According to other example embodiments, the computer apparatus 200 may include a greater or less number of components than a number of components shown in FIG. 2. However, there is no need to clearly illustrate many components according to the related art. For example, the computer apparatus 200 may include at least a portion of the I/O apparatus 250, or may further include other components, for example, a transceiver, a database (DB), and the like.

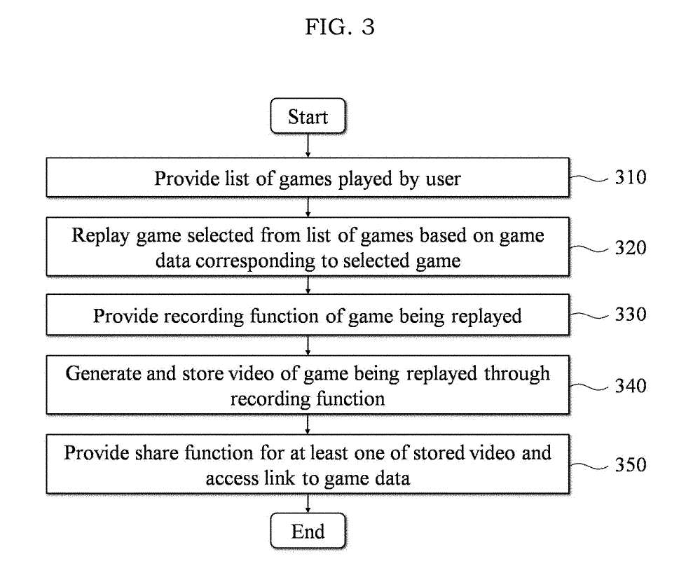

FIG. 3 is a flowchart illustrating an example of a game replay method of a client according to at least one example embodiment. The game replay method according to the example embodiment may be performed by the computer apparatus 200 that implements one of the plurality of electronic devices 110, 120, 130, and 140 of FIG. 1. For example, the processor 220 of the computer apparatus 200 may be configured to execute a control instruction according to a code of at least one program or a code of an OS included in the memory 210. Here, the processor 220 may control the computer apparatus 200 to perform operations 310 to 350 included in the game replay method of FIG. 3 in response to a control instruction provided from a code stored in the computer apparatus 200.

Referring to FIG. 3, in operation 310, the computer apparatus 200 may provide a list of games played by a user. As is known, the term “game” can be used to refer to a particular game application or an instance of a particular game application. For example, in operation 310, the apparatus 200 may provide a list of games that a user has played. Further, according to at least some example embodiments, the list of games may list, as “games,” multiple different instances (e.g., game play sessions) of one or more games (e.g., game applications). For example, if, during a sample period of time, a user played game application #1 five times and played game application #2 three times, the list of games provided in operation 310 may include at least eight entries (i.e., eight “games”) corresponding to the eight total times the user played one of game applications #1 and #2 during the sample period of time.

According to an example embodiment, the computer apparatus 200 may provide a game service to the user under control of a game application installed and executed on the computer apparatus 200. The user may play a game using the computer apparatus 200 through the provided game service. Here, a list of games played by the user may be stored in the computer apparatus 200. According to another example embodiment, the computer apparatus 200 may provide a game service to the user through communication with a game server under control of a game application installed and executed on the computer apparatus 200. In this case, the user may play the game while communicating with the game server using the computer apparatus 200 through the provided game service. Here, a list of games played by the user may be stored in the game server and the computer apparatus 200 may receive and provide the list of games through communication with the game server under control of the game application. For example, according to at least some example embodiments, the computer apparatus may request, from the game server, a list of games a user has played.

In operation 320, the computer apparatus 200 may replay a game selected from the list of games based on game data corresponding to the selected game. Game data corresponding to each game may be generated, stored, and managed using the computer apparatus 200 or the game server depending on example embodiments. Here, the game data may refer to data used for replaying the corresponding game and may include information, for example, various types of parameters, an input value of the user, and an input point in time, according to the progress of the game. Replay of the game may be a process of playing again a previous game as is by applying the various parameters and input values included in the game data to a game logic. That is, in operation 320, the computer apparatus 200 may replay the corresponding game by applying the game data to the game logic of the game application installed and executed on the computer apparatus 200.

For example, according to at least some example embodiments, the aforementioned game data can include sequences of user game input. For example when a user plays a game, a user may perform a series of operations (e.g., touching certain portions of a screen or other input device of a terminal, speaking certain words or phrases for voice-controlled games, moving or tilting a motion detection-capable terminal for motion-controlled games, etc.) through a terminal in order to perform certain in-game actions. The series of operations may be interpreted by the terminal upon which the game is being played as user game input. According to the programming of a game application, the game application (i.e., the one or more processors executing computer code corresponding to the game in the terminal upon which the game is being played) will respond to particular user game input in a specified manner.

According to at least some example embodiments, sequences of user game input corresponding to user operations performed by a user through the terminal during the act of playing a game may be recorded and stored. Thus, a stored sequence of user game input can correspond to a game play session of a game application, or a portion of a game play session. Alternatively, sequences of user game input corresponding to a desired operation of a game can be generated directly, and stored, without recording user game input corresponding to user operations performed by a user through the terminal during the act of playing a game. Examples of user game input include, but are not limited to, input for controlling movements and/or actions of an in-game avatar (e.g., moving the player avatar up, moving player avatar left, causing the player avatar to attack enemy 2, etc.), and input for selecting, moving, or otherwise manipulating in-game objects.

Accordingly, replaying a selected game in operation 320 may include, for example, the computer apparatus 200 presenting one or more previously stored sequences of user game input to a game application such that the game application (i.e., the processor 220 executing computer code corresponding to the game application) reacts as if the previously stored sequence of user game input corresponds to current operations of a user playing the game application on the computer apparatus 200, without the need for a user to actually re-perform (e.g., via the computer apparatus 200) the operations corresponding to the previously stored sequence of user game input.

Consequently, replaying a game in the manner of operation 320 is distinct from simply replaying previously recorded video footage of a game being played. For example, according to at least some example embodiments, operation 320 includes executing the game application (e.g., the computer code) corresponding to the game being replayed. In contrast, replaying previously recorded video footage of a game can be accomplished by executing a video playback application, and need not include the execution the game application corresponding to the game at all.

Returning to FIG. 3, in operation 330, the computer apparatus 200 may provide a recording function of the game being replayed. For example, the recording function may be a function of capturing a screen of a game currently being replayed and generating a video for the game being replayed. According to at least some example embodiments, the game application corresponding to the game being replayed may include a recording function, and operation 330 may include performing the recording function under control of the game application (e.g., the processor 220 executing recording function-related instructions included in computer code of the game application). According to at least some other example embodiments, the recording function may be provided by a recording application separate from the game application corresponding to the game being replayed, and operation 330 may include performing the recording function under control of the separate recording application (e.g., the processor 220 executing recording function-related instructions included in computer code of the separate recording application).

In operation 340, the computer apparatus 200 may generate and store a video of the game being replayed through the recording function. For example, the computer apparatus 200 may generate a video of a game being replayed during a desired period of time from a point in time at which an input of the user occurs and may store the generated video in the computer apparatus 200 that is a terminal of the user, through the recording function.

In operation 350, the computer apparatus 200 may provide a share function for at least one of the stored video and an access link to the game data. For example, the share function may be provided through a screen on which the game is being replayed. According to an example embodiment, the computer apparatus 200 may receive a selection on the stored video through the share function. For example, the computer apparatus 200 may provide a list of videos stored in the computer apparatus 200 and may identify a video selected from the provided list of videos. Also, the computer apparatus 200 may provide a list of share platforms through the share function in response to a selection on the video. Here, the share platform may be one of platforms for various types of social network services (SNSs) and platforms capable of sharing the video and/or the access link to game data with another user, such as an e-mail platform and a map platform. Here, the computer apparatus 200 may execute a share application corresponding to a share platform selected from the list of share platforms, and may transmit the selected video and/or access link to game data to the executed share application. For example, the game application may call execution of a specific share application through the share function and may transmit the video and/or access link to the executed share application.

For example, in response to selecting and executing an instant chatting application as the share application, the computer apparatus 200 may provide the video and/or access link to another user selected by the user under control of the instant chatting application. In detail, the instant chatting application may control the computer apparatus 200 to establish a communication session between accounts of the user and the other user and to transmit an instant message including the video and/or access link through the established communication session. As another example, another SNS application may control the computer apparatus 200 to post the video and/or access link through a timeline of the user.

Here, users that receive the video and/or access link may be users of the game service or may not be one of the users. Accordingly, the access link or a server connected through the access link may include a function of executing the game application when the game application is to be installed on the terminal of the user selecting the access link or when the game application is installed on the terminal of the user. For example, the access link may include information, for example, a uniform resource locator (URL), on a location on a network at which game data is stored, and may further include information for installing or executing the game application capable of replaying the game using game data. The terminal of the user that selects the access link may install or execute the game application based on information for installing or executing the game application, may receive game data based on the location on the network, and may replay the game selected by the user. As another example, the access link may include only information, for example, a URL, on the location on the network at which game data is stored. In this case, when the server that stores the game data at the location on the network provides an instruction for installing or executing the game application capable of replaying the game using the game data to the terminal of the user, the game selected by the user may be replayed on the terminal of the user.

The game according to another example embodiment may include games of different categories such as an attack game played by the user as an attacker, a defense game played by the user as a defender, and a participation game in which a user participates after being initiated by other users. Here, the list of games may include a list of attack games, a list of defense games, and a list of participation games.

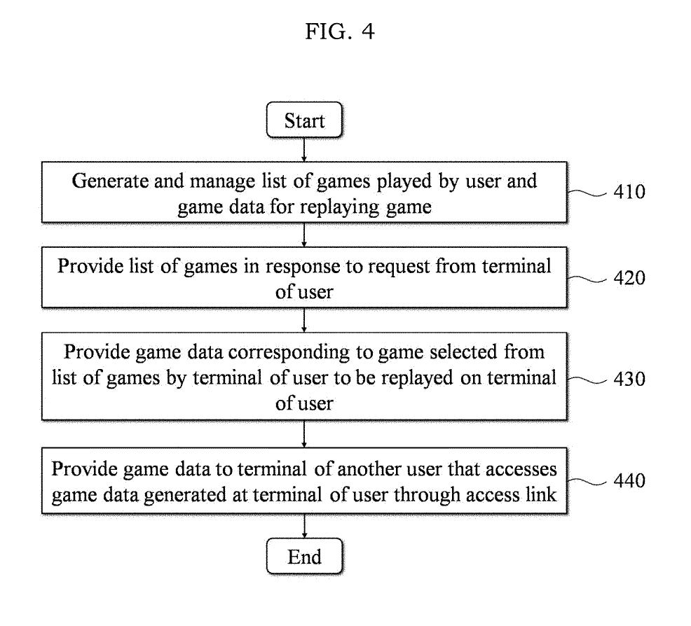

FIG. 4 is a flowchart illustrating an example of a game replay method of a server according to at least one example embodiment. The game replay method of FIG. 4 may be performed by the computer apparatus 200 that implements, for example, the server 150 of FIG. 1. For example, the processor 220 of the computer apparatus 200 may be configured to execute a control instruction according to a code of at least one program or a code of an OS included in the memory 210. Here, the processor 220 may control the computer apparatus 200 to perform operations 410 to 440 included in the game replay method of FIG. 4 in response to the control instruction provided from the code stored in the computer apparatus 200.

Referring to FIG. 4, in operation 410, the computer apparatus 200 may generate and manage a list of games played by a user and game data for replaying a game. According to an example embodiment, the computer apparatus 200 may perform communication for providing a game service with a terminal of the user connected under control of a game application as the game server. The user may play a game using the terminal of the user through the provided game service. Here, a list of games played by the user may be stored in the computer apparatus 200.

In operation 420, the computer apparatus 200 may provide the list of games in response to a request from the terminal of the user. For example, the list of games played by the user may be stored in the computer apparatus 200 as the aforementioned game server and may be provided to the terminal of the user through a network in response to a request from the terminal of the user through the game application.

In operation 430, the computer apparatus 200 may provide game data corresponding to a game selected from the list of games by the terminal of the user to be replayed on the terminal of the user. For example, game data corresponding to each game may be generated, stored, and managed in the game server depending on example embodiments. Here, the game data refers to data used for replaying the corresponding game and may include information, for example, various types of parameters, an input value of the user, and an input point in time, according to the progress of the game. Replay of the game may be a process of playing again a previous game as is by applying the various parameters and input values included in the game data to a game logic. That is, in operation 430, the computer apparatus 200 may apply the game data to the game logic of the game application installed and executed on the terminal of the user, and may transmit game data corresponding to the selected game to the terminal of the user over the network so that the selected game may be replayed on the terminal of the user.

The game selected by the user from the list of games based on the game data may be replayed on the terminal of the user. Also, the terminal of the user may provide a recording function of the game being replayed. For example, the recording function may be a function of capturing a screen of a game currently being replayed and generating a video for the game being replayed. Also, the terminal of the user may generate and store a video of the game being replayed through the recording function. For example, the terminal of the user may generate a video of a game being replayed during a desired period of time from a point in time at which an input of the user occurs and may store the generated video in the terminal of the user, through the recording function.

As described above, the terminal of the user may provide a share function for at least one of the stored video and an access link to the game data. For example, the share function may be provided through a screen on which the game is being replayed. According to an example embodiment, the terminal of the user may receive a selection on the stored video through the share function. For example, the terminal of the user may provide a list of videos stored in the terminal of the user and may identify a video selected from the provided list of videos. Also, the terminal of the user may provide a list of share platforms through the share function in response to a selection on the video. Here, the share platform may be one of platforms for various types of SNSs and platforms capable of sharing the video and/or the access link to game data with another user, such as an e-mail platform and a map platform. Here, the terminal of the user may execute a share application corresponding to a share platform selected from the list of share platforms and may transmit the selected video and/or access link to game data to the executed share application. For example, the game application installed and executed on the terminal of the user may call execution of a specific share application through the share function and may transmit the video and/or access link to the executed share application.

For example, in response to selecting and executing an instant chatting application as the share application, the terminal of the user may provide the video and/or access link to another user selected by the user under control of the instant chatting application. In detail, the instant chatting application may control the terminal of the user to establish a communication session between accounts of the user and the other user and to transmit an instant message including the video and/or access link through the established communication session. As another example, another SNS application may control the terminal of the user to post the video and/or access link through a timeline of the user.

Here, users that receive the video and/or access link may be users of the game service or may not be one of the users. Accordingly, the access link or a server, for example, the computer apparatus 200 in the example embodiment, connected through the access link may include a function of executing the game application when the game application is to be installed on the terminal of the user selecting the access link or when the game application is installed on the terminal of the user. For example, the access link may include information, for example, a URL, on a location on a network at which game data is stored, and may further include information for installing or executing the game application capable of replaying the game using game data. The terminal of the user that selects the access link may install or execute the game application based on information for installing or executing the game application, may receive game data based on the location on the network, and may replay the game selected by the user. As another example, the access link may include only information, for example, a URL, on the location on the network at which game data is stored. In this case, when the computer apparatus 200 that stores game data at the location on the network provides an instruction for installing or executing the game application capable of replaying the game using the game data to the terminal of the user, the game selected by the user may be replayed on the terminal of the user.

The game according to another example embodiment may include an attack game played by the user as an attacker, a defense game played by the user as a defender, and games of different categories of participation games played by participating in a game between other users. Here, the list of games may include a list of attack games, a list of defense games, and a list of participation games.

In operation 440, the computer apparatus 200 may provide game data to a terminal of another user that accesses the game data generated at the terminal of the user through the access link. As described above, the access link may be generated at the terminal of the user and shared with other users through the share platform. When another user accesses the computer apparatus 200 through the access link, the computer apparatus 200 may transmit game data corresponding to the access link to a terminal of the other user over the network. Also, in response to the access of the other user through the access link, the computer apparatus 200 may transmit, to the terminal of the other user, an instruction for installing a game application for replaying a game corresponding to game data on the terminal of the other user on the terminal of the other user or an instruction for executing the game application installed on the terminal of the other user.

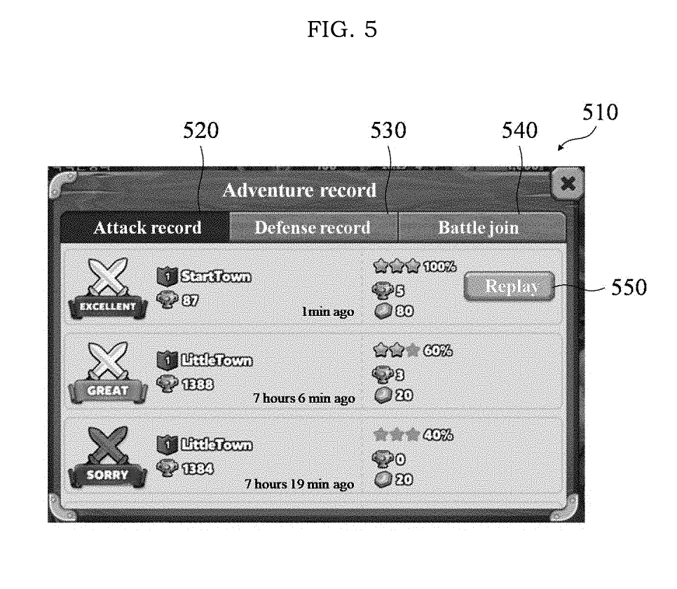

FIG. 5 illustrates an example of a list of games according to at least one example embodiment. FIG. 5 illustrates an example of a list of games displayed in a popup form on a game screen. An adventure record 510 is provided as a popup window for the list of games. Here, an attack record 520 is an example of a list of attack games, a defense record 530 is a list of defense games, and a battle join 540 shows category-by-category lists in a form of a tab for displaying a list of participation games. Here, at least one game included in the list may include a user interface for replaying a corresponding game, such as a replay button 550. In response to a user selecting the replay button 550, for example, touching an area on which the replay button 550 is displayed in a touchscreen environment, the corresponding game may be replayed.

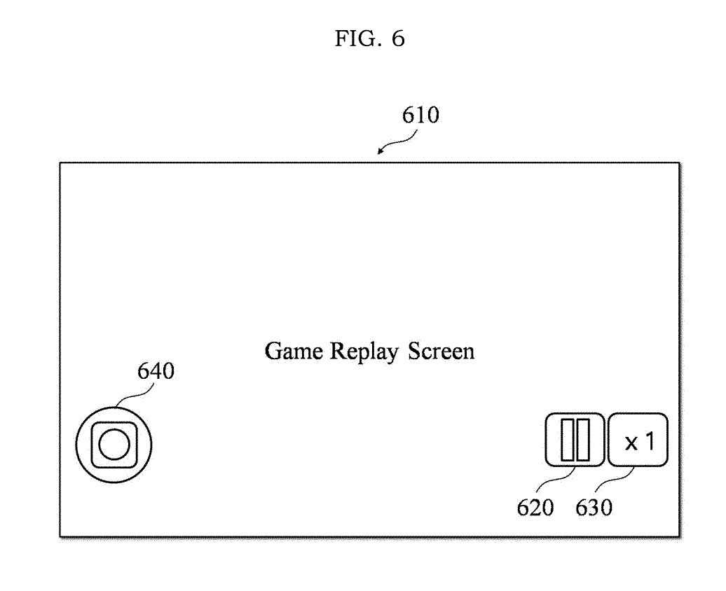

FIG. 6 illustrates an example of a game replay screen according to at least one example embodiment. FIG. 6 illustrates an example of a screen 610 on which a game is replayed. Here, replay of a game refers to playing again a previously played game. Basic contents of the screen 610 may be representations of contents of the previously played game and the screen 610 may vary based on a game. The screen 610 of FIG. 6 may include user interfaces for replay. A first button 620 displayed on the screen 610 may be a user interface for pausing the game being replayed, a second button 630 may be a user interface for controlling a replay speed. For example, every time the user selects the second button 630, the replay speed may be controlled to be, for example, 1×, 2×, 4×, and 1×again.

The screen 610 may further include a recording button 640 for the game being played. In response to a selection on the recording button 640, for example, a terminal of the user may generate and store a video by recording the game being replayed during a desired period of time, for example, 10 seconds from a point in time at which the recording button 640 is selected. Depending on example embodiments, the video may be generated and stored by recording the game during a period of time from a point in time at which the user presses the recording button 640 once to a point in time at which the user presses the recording button 640 again.

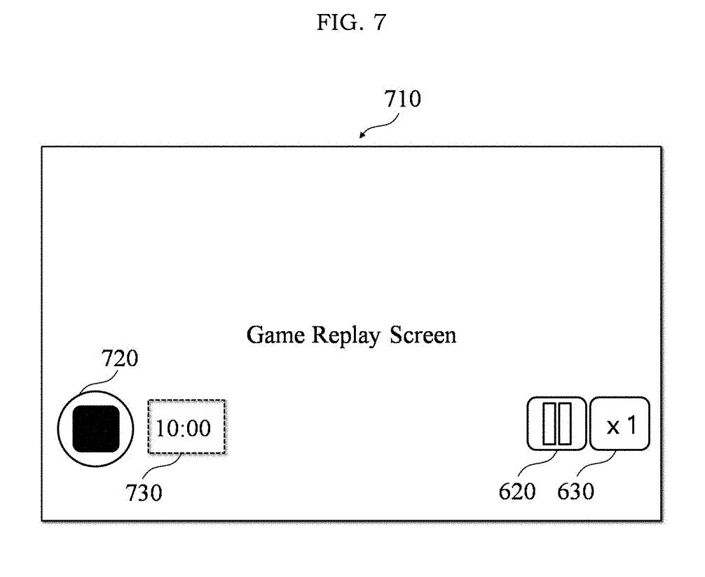

FIG. 7 illustrates an example of a recording process according to at least one example embodiment. FIG. 7 illustrates an example of a screen 710 on which the recording button 640 of FIG. 6 is replaced with a recording button 720 indicating currently recording in response to the user selecting the recording button 640 displayed on the screen 610 of FIG. 6 and a desired time, for example, 10 seconds, is indicated on a box 730 indicated with broken lines. The time indicated on the box 730 may back count from 10 seconds to zero second. Once the time is over, the recording may be terminated and a video with the length of 10 seconds may be generated.

Here, once the recording is terminated, the screen 710 of FIG. 7 may return to, that is, be replaced with the screen 610 of FIG. 6. A user interface for sharing the generated video may be further displayed.

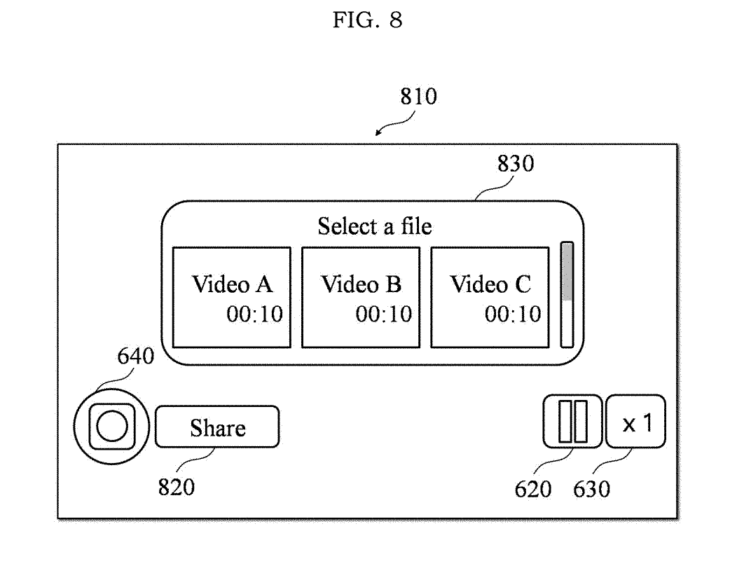

FIG. 8 illustrates an example of a video selection process according to at least one example embodiment. FIG. 8 illustrates an example of a screen 810 on which a user interface, such as a share button 820, for sharing a generated video is displayed. In response to the user selecting the share button 820, a list 830 of stored videos may be provided in a form of a popup window. The user may select a video to be shared using the list 830 of videos.

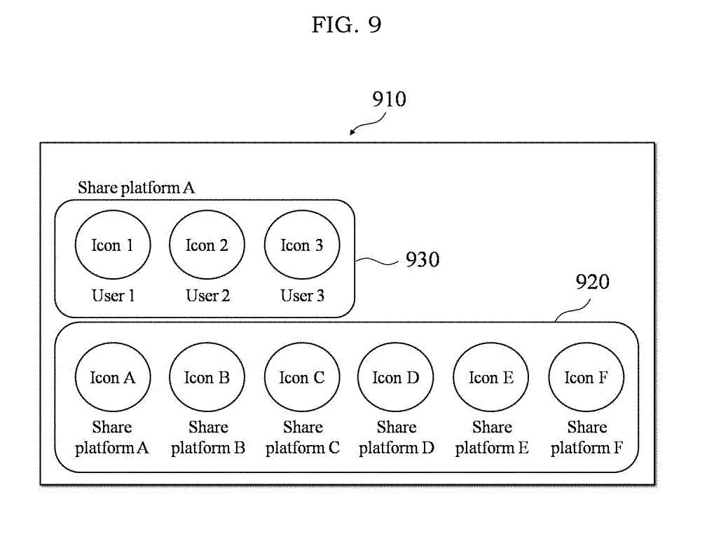

FIG. 9 illustrates an example of a list of share platforms according to at least one example embodiment. FIG. 9 illustrates an example of a screen 910 on which a list 920 of share platforms is displayed in response to a selection on a video to be shared in FIG. 8. The user may select a share platform for sharing a video and game data from the list 920 of share platforms.

Here, a corresponding game may include a share platform, or a specific share platform may be linked with a game, such as the game being provided from the share platform. In this case, users having a relationship set therebetween in the game may use the same relationship on the specific share platform. A list 930 displayed on the screen 910 includes accounts of users playing the corresponding game among users having a relationship set with the user on a share platform A if the share platform A and the game are related to each other. For example, if the user selects a user 1, a video and game data may be directly shared with the user 1 through the share platform A.

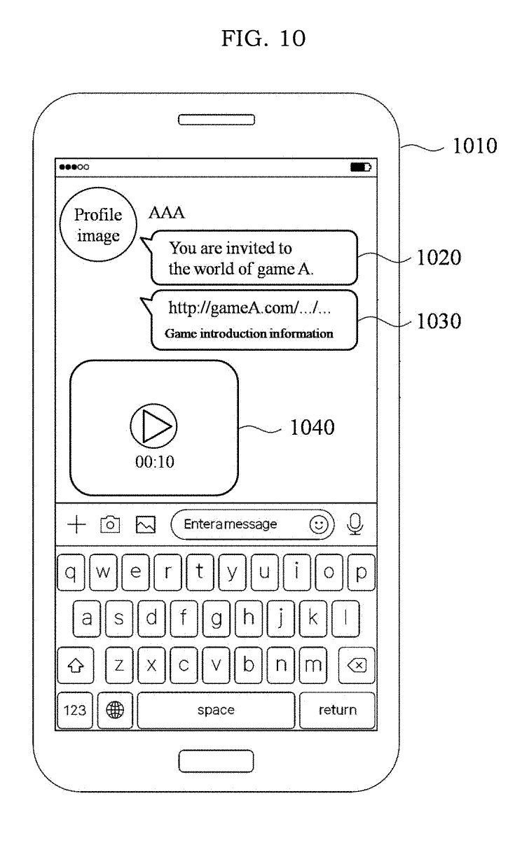

FIG. 10 illustrates an example of information shared through a share platform according to at least one example embodiment. FIG. 10 illustrates an example of a screen of a terminal 1010 of another user with whom the user shares a video and an access link to game data. Referring to FIG. 10, a first message 1020 includes invitation message content to a game A, a second message 1030 includes an access link to game data and game introduction information, and a third message 1040 includes a video selected by the user. If another user selects the video of the third message 1040, the corresponding video may be played. If the user selects the access link of the second message 1030, the user may access a network location at which the corresponding game data is stored and may download the game data.

As described above, the terminal 1010 may install or execute a game application through a function included in the access link of the second message 1030, or may install or execute the game application in response to an instruction from a game server of a game A that stores the game data.

Although the example embodiments of simultaneously sharing a video and an access link to game data are described with reference to FIGS. 6 and 10, an example embodiment of selectively sharing the video and the access link to game data may be included in the example embodiments.

According to some example embodiments, it is possible to replay content of a game played by game users, to generate a video of the game being replayed, and to share the video and/or a link for playing the game with other users.

According to at least some example embodiments, a total size of the game data recorded while a game is being played for the purpose enabling the replaying of a portion of the game may be smaller than a size of a video file capturing video of the portion of the game. Thus, according to at least some example embodiments, a game application can include the function of automatically capturing game data corresponding to each of one or more game play sessions of the game application instead of automatically capturing video corresponding to each of one or more game play sessions of the game application, thereby providing the user with the ability to share their in-game activities, exploits and achievements with other users while using reduced space (e.g., in memory 210). Further, according to example embodiments, a user can selectively generate video capture data for the game play sessions the user chooses by using the previously stored game data corresponding to the chosen game play sessions to replay the chosen game play sessions, and recording only the replayed game play sessions. Thus, the user is able to share video of selected game play sessions without the processing costs or data size requirements associated with generating video data for every game play session, and without the need to know which game play sessions the user will eventually want to record for video before the game play sessions occur.

The systems and or apparatuses described herein may be implemented using hardware components, software components, and/or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable storage mediums.

The methods according to the example embodiments may be recorded in non-transitory computer-readable media including program instructions (e.g., computer-executable instructions) to implement various operations embodied by a computer. The media may also include, alone or in combination with the program instructions, data files, data structures, and the like. The media and program instructions may be those specially designed and constructed for the purposes, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as floptical disks; and hardware devices that are specially to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be to act as one or more software modules in order to perform the operations of the above-described embodiments, or vice versa.

Example embodiments of the inventive concepts having thus been described, it will be obvious that the same may be varied in many ways. Such variations are not to be regarded as a departure from the intended spirit and scope of example embodiments of the inventive concepts, and all such modifications as would be obvious to one skilled in the art are intended to be included within the scope of the following claims.

What is claimed is:

1. A game replay method comprising:
providing a list of games played by a user;
replaying a game selected from the list of games based on game data corresponding to the selected game;
providing a recording function of the game being replayed;
generating and storing a video of the game being replayed through the recording function; and
providing a share function for at least one of the stored video and an access link to the game data.

2. The game replay method of claim 1, wherein the providing of the share function comprises:
receiving a selection on the stored video through the share function;
providing a list of share platforms through the share function;
executing a share application corresponding to a share platform selected from the provided list of share platforms; and
transmitting the selected video and the access link to the game data to the executed share application.

3. The game replay method of claim 2, wherein the access link includes,
information on a location in a network at which the game data is stored, and
information to install or execute a game application capable of replaying the game using the game data.

4. The game replay method of claim 2,
wherein the access link includes information on a location in a network at which the game data is stored, and
wherein the method further comprises providing, by a server that stores the game data at the location in the network, an instruction for installing or executing a game application capable of replaying the game using the game data.

5. The game replay method of claim 1, wherein the providing of the list of games comprises receiving the list of games from a server that generates and stores the list of games played by the user and game data corresponding to each of the games included in the list, and displaying the received list of games on a screen.

6. The game replay method of claim 1,
wherein the game includes at least one of an attack game played by the user as an attacker, a defense game played by the user as a defender, and a participation game in which a user participates after being initiated by other users, and
wherein the list of games comprises a list of attack games, a list of defense games, and a list of participation games.

7. The game replay method of claim 1, wherein the generating and the storing of the video comprises:
generating a video of a game being replayed during a desired period of time from a point in time at which an input of the user occurs through the recording function, and storing the generated video on a terminal of the user.

8. A game replay method comprising:
generating a list of games played by a first user and game data for replaying a game;
providing the list of games in response to a request from a terminal of the first user;
providing game data corresponding to a game selected from the list of games by the terminal of the first user to be replayed on the terminal of the first user; and
providing the game data to a terminal of a second user that accesses the game data generated at the terminal of the first user through an access link.

9. The game replay method of claim 8, further comprising:
replaying the selected game on the terminal of the first user, based on the game data under control of a game application that is installed and executed on the terminal of the first user;
generating a video through a recording function provided under control of the game application while the selected game is being replayed; and
transmitting the generated video and an access link to the game data to the second user through a share application selected through a share function.

10. The game replay method of claim 8,
wherein the game includes at least one of an attack game played by the first user as an attacker, a defense game played by the first user as a defender, and a participation game in which a user participates after being initiated by other users, and
wherein the list of games comprises a list of attack games, a list of defense games, and a list of participation games.

11. A non-transitory computer-readable recording medium storing instructions that, when executed by a processor, cause the processor to perform the game replay method of claim 1.

12. A computer apparatus comprising:
memory storing computer-executable instructions; and
at least one processor configured to execute computer-executable instructions such that the at least one processor is configured to,
generate a list of games played by a first user and game data for replaying a game,
provide the list of games in response to a request from a terminal of the first user,
provide game data corresponding to a game selected from the list of games by the terminal of the first user to be replayed on the terminal of the first user, and
provide the game data to a terminal of a second user that accesses the game data generated at the terminal of the first user through an access link.

13. The computer apparatus of claim 12, wherein the at least one processor configured to execute computer-executable instructions such that the at least one processor is further configured to,
replay the selected game on the terminal of the first user, based on the game data under control of a game application that is installed and executed on the terminal of the first user,
generate a video through a recording function provided under control of the game application while the selected game is being replayed, and
transmit the generated video and an access link to the game data to the second user through a share application selected through a share function.

14. The computer apparatus of claim 12,
wherein the game includes at least one of an attack game played by the first user as an attacker, a defense game played by the first user as a defender, and a participation game in which a user participates after being initiated by other users, and
wherein the list of games comprises a list of attack games, a list of defense games, and a list of participation games.
